(19) United States
(12) Patent Application Publication
(10) Pub. No.: US 2014/0162583 A1
(43) Pub. Date: Jun. 12, 2014

(54) PROVIDING EMERGENCY INFORMATION VIA EMERGENCY ALERT MESSAGES

(71) Applicant: AT&T INTELLECTUAL PROPERTY I, LP, Atlanta, GA (US)

(72) Inventors: Brian Kevin Daly, Peachtree Corners, GA (US); Charles Peter Musgrove, Henderson, NV (US); DeWayne A. Sennett, Redmond, WA (US)

(73) Assignee: AT&T INTELLECTUAL PROPERTY I, LP, Atlanta, GA (US)

(21) Appl. No.: 13/708,574

(22) Filed: Dec. 7, 2012

(51) Int. Cl. H04W 4/22

(52) U.S. Cl. CPC H04W 4/22
USPC 455/404.1

(57) ABSTRACT

An emergency alert message may be distributed to notify the public of an emergency condition. Recipients of the emergency alert message be determined, for example, based on a geographic region. A recipient may receive an emergency alert message and may be informed that an emergency condition has been reported to emergency response personnel. The distribution of an emergency alert message may be broadcast or tailored to specific recipients according to various embodiments.

### TECHNICAL FIELD

The technical field generally relates to public safety, and more specifically relates to providing information to identified recipients via an emergency call center.

### BACKGROUND

In an emergency situation, an individual can call 9-1-1 to obtain a quick response. The caller can explain the emergency situation to the 9-1-1 call taker, and the 9-1-1 call taker can dispatch appropriate personnel to handle the emergency. Callers typically report an emergency situation without knowledge of what has been previously been reported.

### SUMMARY

The following presents a simplified summary that describes some aspects or embodiments of the subject disclosure. This summary is not an extensive overview of the disclosure. Indeed, additional or alternative embodiments of the subject disclosure may be available beyond those described in the summary.

An emergency alert message may be generated and distributed to inform the public of an emergency condition. In an example embodiment, one or more emergency calls may be received. The emergency calls may comprise reported information that is associated with an emergency condition. The emergency calls may be analyzed, and an emergency alert message may be generated. The emergency alert message may comprise at least a portion of the information that was reported via the emergency calls. One or more characteristics may be determined that are associated with intended recipients of the emergency alert message. Actual recipients may be determined by determining potential recipients that are associated with at least one of the one or more characteristics. The emergency alert message may be distributed to recipients that are associated with a characteristic that is associated with intended recipients. For example, the emergency alert message may be distributed to recipients that are located in a specific geographic region relative to a location of an emergency condition.

The distribution of the emergency alert messages may reduce redundant emergency calls to an emergency call taker. Further, as described herein, the distribution of emergency alert messages may allow portions of the public to be informed of appropriate details associated with emergency conditions.

### BRIEF DESCRIPTION OF THE DRAWINGS

Reference is made here to the accompanying drawings, which are not necessarily drawn to scale.

FIG. 1 illustrates an example system and process for providing emergency information in response to at least one emergency calls.

FIG. 2 is a flow diagram of an example process for distributing emergency alert messages to appropriate recipients.

FIG. 3 is a block diagram of an example wireless communications device that is configurable to initiate emergency calls and receive emergency alert messages.

FIG. 4 is a block diagram of a network entity that is configurable to facilitate the generation and distribution of emergency alert messages.

FIG. 5 depicts an overall block diagram of an exemplary packet-based mobile cellular network environment, such as a GPRS network, in which emergency alert mechanisms may be implemented.

FIG. 6 illustrates an architecture of a typical GPRS network in which emergency alert mechanisms may be implemented.

FIG. 7 illustrates an exemplary block diagram view of a GSM/GPRS/IP multimedia network architecture within which emergency alert mechanisms may be implemented.

FIG. 8 illustrates a PLMN block diagram view of an exemplary architecture in which emergency alert mechanisms may be incorporated.

### DETAILED DESCRIPTION OF ILLUSTRATIVE EMBODIMENTS

Aspects of the instant disclosure are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

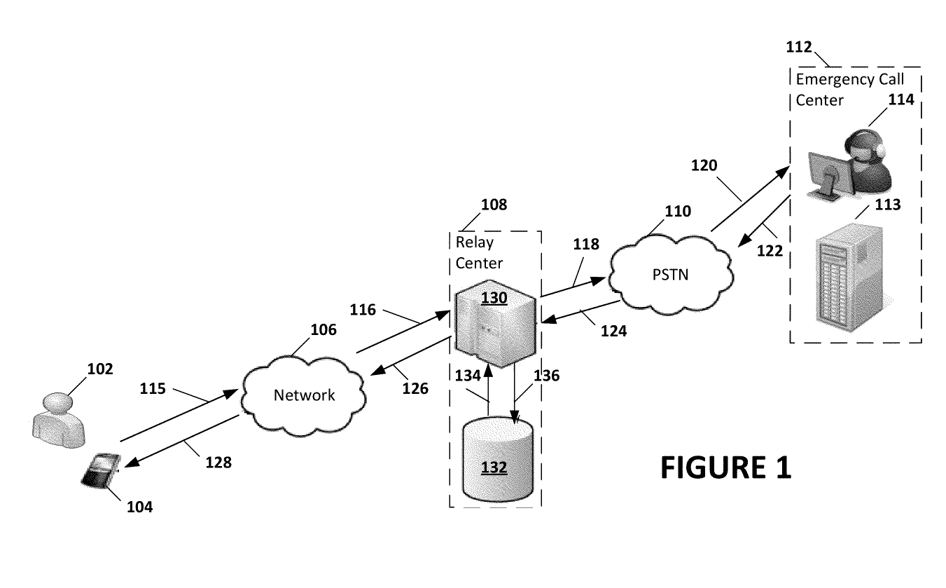

FIG. 1 illustrates an example system and process for providing emergency information in response to one or more emergency calls. As depicted in FIG. 1, a user (e.g., subscriber) 102, may make an emergency call to an emergency call center, for example (e.g., to 9-1-1). The user 102 can initiate a call via a communications device 104, to a relay service center 108, via a wireless network 106. The call can be in the form of any appropriate call or emergency message. In an example embodiment, the emergency call center 112 may receive an emergency message from the user 102. The user 102 may render the emergency message (e.g., 9-1-1 call) to report an emergency such as, for example, a fire, traffic accident, health condition, or the like. The emergency call center 112 may analyze information that reported in the emergency message. Based on the analysis, the emergency call center 112 may determine whether to distribute an emergency alert message to one or more recipients. Such an emergency alert message may provide recipients with various information such as, without limitation, a status of the emergency response, details of the emergency itself, escape routes, or the like. The emergency alert message may inform the recipients that an emergency has been reported so that the recipients know that they do not need to report the emergency. This may prevent redundant emergency messages from being transmitted to the emergency call center 112, thereby mitigating the congestion of network resources and/or the congestion of the emergency call center. In an example embodiment, an emergency alert message may be broadcast to recipients that are within a geographic region associated with the emergency. In another example embodiment, the distribution of the emergency alert message may be tailored so that certain recipients receive the message. In another example distribution, an emergency alert message may be sent to an emergency caller in response to receiving an emergency call from the caller. Such an alert message may inform the caller of details associated with an emergency, and the alert message may provide the caller with an option to proceed to a 9-1-1 operator, for example, if the caller wants to provide additional details pertaining to the emergency.

An emergency call may be initiated by a user of 102 of the device 104. The call may be in the form of a voice call, a text message, a message comprising video, an instant messaging-like message, a Short Message Service (SMS) message, a Multimedia Messaging Service (MMS) message, a web chat, or the like. The user 102 may start an application that has previously been installed on his/her communications device 104. The application can provide the user 102, via a user interface, or the like, on the communications device 104, the option to initiate a non-voice based (e.g., text based) session.

At steps 115 and 116, the communications device 104 may send the call to the relay center 108 via the network 106 (e.g., radio access network or the like). The relay service center 108 may comprise a network server 130 and a database 132. The network server 130 may comprise any server, processor, computer, or the like, or any appropriate combination thereof. In various example embodiments, the network server 130 may be configured to receive and/or send messages, analyze messages, process messages, assess and/or determine an emergency condition, generate messages, determine recipients of messages, or any appropriate combination thereof. The relay service center may process and/or relay the call to the emergency call center 112, via the public switched telephone network (PSTN), for example.

Upon receipt and analysis of the call at the emergency call center 112, it may be determined that an emergency condition exists. Examples of emergency conditions may include life threatening health condition (e.g., heart attack) being experienced by the subscriber, life threatening health condition occurring to another individual near the location of the subscriber (e.g., spouse, child, neighbor, friend), fire in the location of the subscriber, fire in the neighboring buildings of the subscriber's location, intruder in the subscriber's home, break-in observed at neighbor's home, automobile accident experienced by the subscriber, and automobile accident observed by the subscriber. The determination may be accomplished via the emergency server 113, an emergency call taker 114, or any appropriate combination thereof. The call may be analyzed in any appropriate manner to determine if an emergency condition exists. Similarly, the call may be analyzed in any appropriate manner identify the emergency condition that exists. For example the emergency call may be implemented using an emergency data message, and the existence and/or identification of the emergency condition may be determined from content in the body of a message, a header of the message, an identifier embedded in the message, a designated field of the message, video contained in the message, a graphic contained in the message, or the like, or any appropriate combination thereof.

The call to the emergency call center 112 can be initiated via any appropriate means for initiating a call to an emergency call center (e.g., 9-1-1 call, call to another number such as fire station, police department, etc., or the like). In an example embodiment, the call to the emergency call center 112 may be a 9-1-1 call that utilizes established mechanisms for location determination and Public Safety Answering Point (PSAP) routing. In the wireless network 106, there may be configuration information that associates every cell site with an appropriate PSAP including instructions on how to address and route calls to that specific PSAP. When an emergency call is initiated by the communications device 104, the wireless network 106 may be instructed, via call set-up signaling, that this is an emergency call. As part of the call set-up processing, the wireless network 106 may know which cell site is connected to the communications device 104 (commonly called the serving cell). Using the identity of the serving cell, the wireless network 106 may use its internal configuration information to determine the PSAP associated with the serving cell. Using the call routing instructions of the associated PSAP, the emergency voice call is established between the communications device 104 and the emergency call center 112 (also known as a PSAP).

When the call from the communications device 104 is answered by the emergency call center 112, the communications device 104 may establish a multi-party call. In an example embodiment, the multi-party call may be between the relay service center 108 and the emergency call center 112. In another example embodiment, the multi-party call may be between the communications device 104, the relay service center 108, and the emergency call center 112. For example, the communications device 104 may establish a conference call between the communications device 104, the relay service center 108, and the emergency call center 112. The relay service center 108 may conduct voice communications with the emergency call center 112. Thus, even if the user 102 is unable to speak or hear, the call taker 114 at the emergency call center 112 will be able to receive background audio and/or video from the environment of the user 102. This background audio and/or video may provide information to the call taker 114 at the emergency call center 112 to assess the urgency and severity of the emergency and to distinguish between actual emergency calls and prank calls. In an example embodiment, the relay service center 108 may maintain separate communications in order to receive messages from the communications device 104 and provide messages to the communications device 104.

Calls that are received by the emergency call center 112 may each comprise information that a user is reporting. The reported information may be associated with a particular emergency condition. The emergency call center may distribute messages based on at least a portion of the reported information. By way of example, and without limitation, the emergency call center may receive one or more emergency calls that each report the same emergency condition, such as a traffic accident. The reported information may be analyzed. For example, after receiving a predetermined number of calls that each report the same emergency condition, an emergency alert message may be generated. After analysis of the information that was reported in the calls, for example, the emergency call center 112 may generate an emergency alert message. The generated emergency alert message may comprise at least a portion of the reported information. For example, the reported information may comprise the address of a traffic accident, and thus the emergency alert message may comprise the address of the accident. The emergency alert message may comprise various other appropriate information such as, for example, alternate traffic routes, a status of response personnel, an expected time that the affected roadways will be cleared, or the like. The emergency alert message may be distributed to recipients that are associated with one or more characteristics. In an example embodiment, the characteristic may refer to a geographic region in which the intended recipients are located, and the emergency alert message may be distributed to recipients that are located within a geographic region. Thus, when recipients receive the emergency alert message people, recipients (e.g., potential emergency callers) that drive by the traffic accident may be assured that the accident has been reported.

In an example embodiment, an emergency call center 112 may utilize the emergency server 113 to analyze emergency calls and/or generate emergency alert messages for distribution to devices, such as the communications device 104. For example, in response to an emergency call, the emergency call center 112 may determine that mobile devices in a specific geographic region should be informed of emergency information via an emergency alert message. In example embodiment, the emergency call center 112 may determine that specific users of mobile devices in a specific geographic region should be informed of emergency information via an emergency alert message. The specific users may be referred to as intended recipients of the emergency alert message. In such an embodiment, the specific user may be selected based on user profile data associated with a mobile device. For example, user profile data may be stored in the database 132 that may be accessed by the network server 130 at 134 and 136. The emergency server 113 may access the user profile data. The emergency alert messages may be distributed to communications devices, such as device 104, in steps 122, 124, 126, and 128, via the PSTN 110 and the wireless network 106. Emergency alert messages may be in the form of a voice call, a text message, a message comprising video, an instant messaging-like message, a Short Message Service (SMS) message, a Multimedia Messaging Service (MMS) message, a web chat, a message comprising a URL, or the like.

As a result of the foregoing described process, the public may be better informed of emergency conditions. Additionally, redundant emergency calls may be prevented, and there may be increased access to wireless networks or emergency networks, and an emergency call taker 114 may be able to coordinate emergency responses efficiently and promptly. Tailored distributions of emergency alert messages may also enable emergency conditions to be resolved. For example, emergency alert messages may be targeted for specific recipients, so that the specific recipients may help resolve an emergency condition without other people in the same geographic area of the specific recipients receiving the emergency alert message.

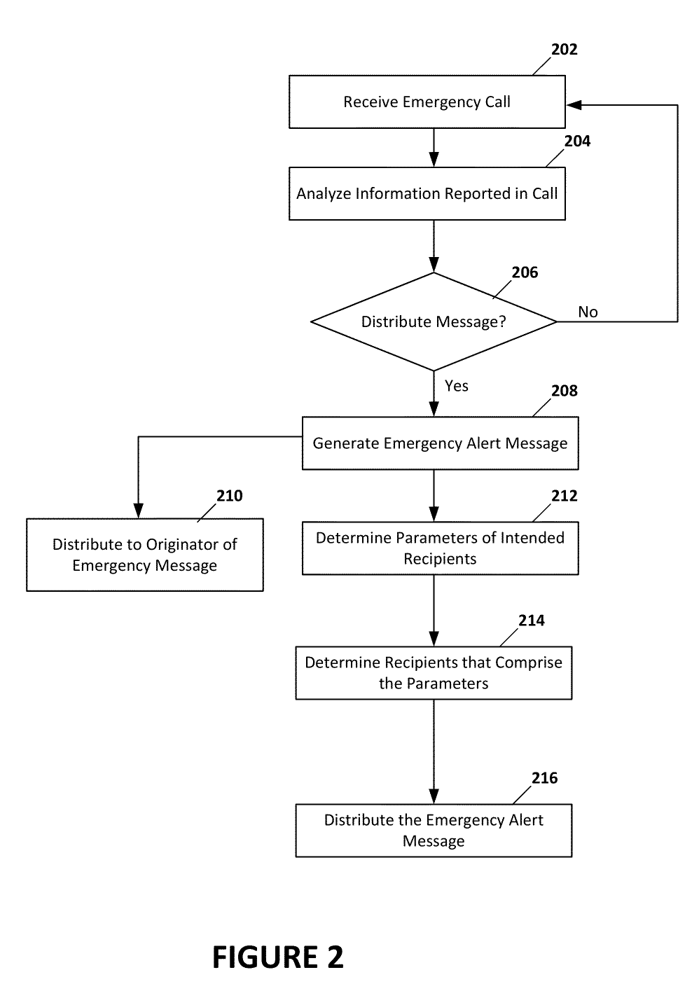

FIG. 2 is a flow diagram of an example process for distributing an emergency alert message to appropriate recipients. An emergency call (e.g., emergency message) is received at 202. The call may comprise information that is reported to an emergency call center. The reported information may be associated with an emergency condition or an emergency situation. At 204, the information that is reported in the emergency call may be analyzed. For example, an emergency condition may be identified based on the analysis. The emergency condition may be classified into a classification such as, for example, fire, traffic, natural disaster, health condition, burglary, violent crime, other police matters, or the like. At 206, the emergency call center may determine whether to distribute a message that informs recipients (e.g., the public) of at least a portion of the reported information.

In an example embodiment, the test at 206 may be based on how many emergency calls which are associated with the same emergency condition have been received. For example, a predetermined threshold may trigger distribution of an emergency alert message. During the analysis at 204, the amount of emergency alert calls that have been received may be determined For example, the emergency call center 112 may determine that a received emergency call is the second call corresponding to the same emergency condition. By way of example, the predetermined threshold may be five, although the predetermined threshold may be one or greater according to various embodiments. If the predetermined threshold is five and the number of the received call is two, the emergency call center may determine that the number is less than the predetermined threshold, and thus the process may return to step 202 where the emergency call taker may receive another emergency call. In such an example, four more emergency calls that report the same emergency condition may be received before an emergency alert message is generated at 208. When the sixth emergency call is received, the test at 206 may determine that an emergency message may be distributed. The numbers and predetermined threshold are used for exemplary purposes, and embodiments are not limited to the examples described herein.

The test at 206 may be based on other criteria besides, or in addition to, how many emergency calls have been received. For example, the test at 206 may be based on the severity of an emergency condition, a classification of an emergency condition, whether the emergency condition is time sensitive, the identity of the emergency caller, or the like. For example, distributing information concerning a minor traffic accident to the public may be occur after a predetermined threshold of emergency calls reporting the traffic accident have been received, while information concerning a tornado may be distributed after the first emergency call.

If it is determined that a message should be distributed, an emergency alert message may be generated at 208. In an example embodiment, the process may proceed to step 210, where the emergency alert message is distributed to the originator of an emergency call (e.g., an emergency caller such as a user 102). In such an embodiment, an emergency alert message may be distributed to an emergency caller in response to receiving an emergency call from the caller, for example, to inform the emergency caller that an emergency condition has already been reported. For example, the location of a caller may be determined, and the location may be determined to be proximate to a location of an emergency condition. Based on the caller's proximity to the emergency condition, an emergency alert message may be distributed to the caller when the caller calls the emergency call center 112, so that the call is aware that the emergency condition has already been reported for example. Such an emergency alert message may comprise reported information so that the caller can be informed of what has already been reported to an emergency call center. The emergency alert message may comprise an option for the caller to proceed with an emergency call so that, for example, a caller may provide additional information that may not have been reported to an emergency call center, or the caller may provide information that is associated with a different emergency condition than the emergency condition that was previously reported.

An emergency alert message may be generated (at 208) to include a least a portion of the information that was reported to an emergency call taker, for example. In example embodiment in which an emergency condition requires an evacuation, the emergency alert message may comprise an evacuation route. An emergency alert message may comprise various information such as, for example, details of an emergency condition, a status of emergency personnel (e.g., where they are, who is coming to the location of the emergency condition), recommended actions to take in response to an emergency condition, or the like. In an example embodiment, an emergency response message may be generated based on a comparison of information that has been reported to an emergency call center 112. For example, one or more emergency calls may be received by an emergency call center 112 (step 202). The calls may report details of an emergency condition. A first emergency call that is received the emergency call center 112 may comprise comprising first reported information associated with the emergency condition. A second emergency call that is received the emergency call center 112 may comprise comprising second reported information associated with the same emergency condition as the first reported information. The first reported information may be compared to the second reported information. A set of information may be determined that is contained in the first reported information and the second reported information. The emergency alert message may be generated to contain the set of information. Thus, reliability of an emergency alert message may be enhanced, for example, because information that is included in the emergency alert message may be based on a plurality of emergency calls. For example, an emergency call center 112 may require that consistent information is reported at least a predetermined number of times before the information is disseminated to the public. The emergency alert message may be generated in the form of a voice call, a text message, a message comprising video, an instant messaging-like message, a Short Message Service (SMS) message, a Multimedia Messaging Service (MMS) message, a web chat, a message comprising a URL, or the like.

At 212, one or more characteristics may be determined that are associated with potential (e.g., intended) recipients of the emergency alert message. Example characteristics may be location-based. For example, a characteristic may define a geographic region, and the potential recipients of the emergency alert message may be the mobile devices and/or mobile device users that are located within the defined geographic region. By way of example, the location of an emergency condition may be determined, via a GPS or the like, and the emergency alert message may be distributed to the mobile devices that are within a specific radius of the location of the emergency condition. By way of another example, a bank robbery may be reported as in-progress via an emergency call, and an emergency alert message may be distributed to users that are located within the bank. The geographic regions described above are presented for exemplary purposes, and an emergency alert message may be distributed in any appropriate geographic region.

In an example configuration, characteristics that are associated with intended recipients may comprise a discriminator. For example, a discriminator may define characteristics that are not part of the characteristics of the intended recipients. Users or devices which comprise the characteristic that is discriminated against may not be an intended recipient. Exemplary characteristics include, without limitation, a user's age, a user's criminal history, a device's make or model, a device's operating system, the user's mobile plan, a user's gender, or the like. Similarly, a discriminator may comprise a characteristic. For example, an example discriminator may be defined as convicted bank robbers. In such an example, if a user comprises or is associated with the characteristic of a convicted bank robber, the user may not be a recipient of the emergency alert message. All other users that are associated with characteristics of the intended recipients (e.g., located in a defined geographic region) and are not associated with the characteristic of the discriminator, may receive the emergency alert message.

At 214, recipients that are associated with the characteristics of the intended recipients may be determined Recipients may refer to a user 102 or device 104, or any appropriate combination thereof. For example, a characteristic of the intended recipients may comprise a geographic region, wherein the geographic region may be defined relative to the location of an emergency condition. The recipients that are associated with the geographic region characteristic may be determined based on location-based data. For example, a network entity, such as the emergency call center 112 or relay service center 108 for example, may identify which devices are currently powered on and are currently located within or proximate to the geographic region. Such an identification may be based on location-based data that each data transmits, location-based data that is accessible via GPS, or the like, for example. In another example configuration, recipients that are associated with characteristics may be determined based on user profile data. For example, a user profile may be associated with a device, a mobile network plan, or the like. After the characteristics of the intended recipients are determined at 212, the users that are associated with the determined characteristics may be identified by comparing user profile data to the characteristics. User profile data may comprise the determined characteristics. For example, the data in a user profile may be matched to at least one of the one or more characteristics, thereby identifying the user associated with the user profile as a recipient of the emergency alert message. For example, user profile data may be stored and retrieved by the emergency alert server, the network server 130, the database 132, or any appropriate combination thereof. User profile data may include user characteristics such as, for example, a user's age, a user's criminal history, a device's make or model, a device's operating system, the user's mobile plan, a user's gender, or the like. In an example scenario, it may be determined, at 210, that intended recipients should be over a certain age, for example, because the emergency alert message may panic younger recipients. At 212, user profile data may be used to determine whether each recipient is over the requisite age.

At 214, the emergency alert message may be distributed to recipients that meet the criteria for distribution. For example, the emergency alert message may be distributed to recipients that are associated with the characteristics of the intended recipients. The emergency alert message may be broadcast to a specific geographic region, for example, to recipients that are located within the geographic region and/or proximate to the geographic region.

In an example embodiment, the test at 206 may be based on a comparison of information contained in an emergency call with information that was distributed in an emergency alert message. For example, a new emergency call may be received at 202, wherein the new emergency alert message is associated with an emergency condition that may have already been reported to the public. During the analysis at 204, it may be determined whether any of the previously reported information comprises new information that is contained in the new emergency call. For example, the new information may be compared to the reported information. If the reported information does not comprise the new information, a new emergency alert message may be generated at 210. The new emergency alert message may comprise at least the new information associated with the emergency condition. The new emergency message may be distributed to the identified recipients at 216. Thus, the status and/or the details of an emergency condition may be updated, for example, in response to an emergency call.

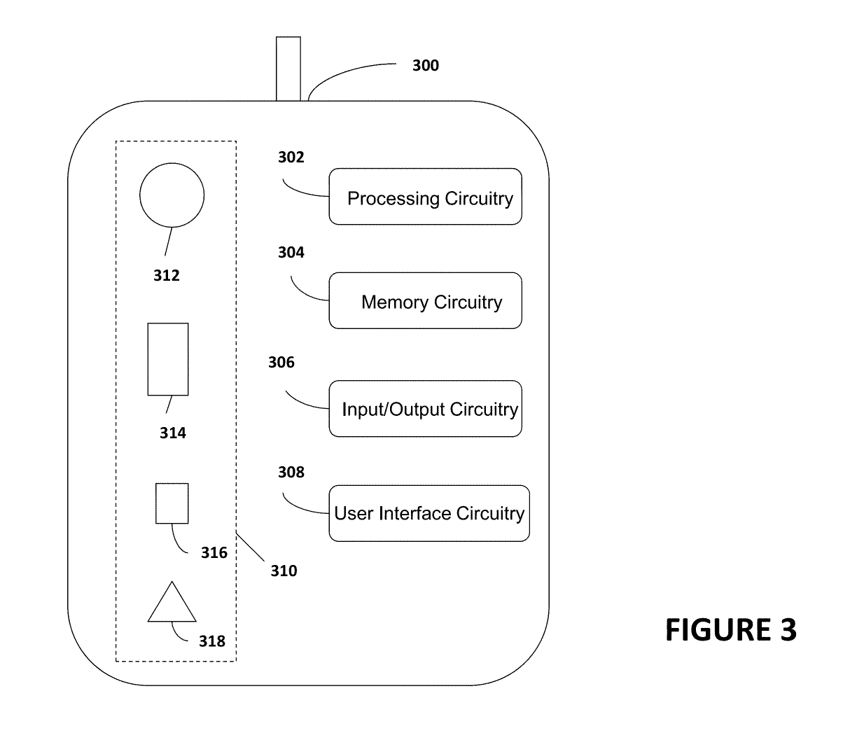

FIG. 3 is a block diagram of an example communications device 300 that is configurable to initiate a call to an emergency call center and receive an emergency alert message. In an example embodiment, the communication device 300 may comprise the communications device 104 described herein, for example, with respect to FIG. 1. In an example configuration, communications device 300 comprises a mobile wireless device. The communications device 300, however, may comprise any appropriate device, examples of which include a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The communications device 300 can include devices that are not typically thought of as portable, such as, for example, a public computing device, a navigation device installed in-vehicle, a set top box, or the like. The mobile communications device 300 can include non-conventional computing devices, such as, for example, a kitchen appliance, a motor vehicle control (e.g., steering wheel), etc., or the like. As evident from the herein description a communications device, a mobile device, or any portion thereof is not to be construed as software per se.

The communications device 300 may include any appropriate device, mechanism, software, and/or hardware for facilitating network congestion mitigation as described herein. In an example embodiment, the ability to determine or provide a connection mechanism is a feature of the communications device 300 that can be turned on and off. Thus, in an example embodiment, an owner of the communications device 300 may opt-in or opt-out of these capabilities.

In an example embodiment, the communications device 300 comprises a processor and memory coupled to the processor. The memory may comprise executable instructions that when executed by the processor cause the processor to effectuate operations associated with network congestion mitigation.

In an example configuration, the communications device 300 comprises a processing portion 302, a memory portion 304, an input/output portion 306, a user interface (UI) portion 308, and sensor circuitry 310 comprising at least one of a video camera portion 312, a force/wave sensor 314, a microphone 316, a moisture sensor 318, or a combination thereof. Each portion of the communications device 300 comprises circuitry for performing functions associated with each respective portion. Thus, each portion can comprise hardware, or a combination of hardware and software. Accordingly, each portion of the communications device 300 is not to be construed as software per se. It is emphasized that the block diagram depiction of communications device 300 is exemplary and not intended to imply a specific implementation and/or configuration. For example, in an example configuration, the communications device 300 may comprise a cellular phone and the processing portion 302 and/or the memory portion 304 may be implemented, in part or in total, on a subscriber identity module (SIM) of the mobile communications device 300. In another example configuration, the communications device 300 may comprise a laptop computer. The laptop computer can include a SIM, and various portions of the processing portion 302 and/or the memory portion 304 can be implemented on the SIM, on the laptop other than the SIM, or any combination thereof.

The processing portion 302, memory portion 304, and input/output portion 306 are coupled together to allow communications therebetween. In various embodiments, the input/output portion 306 comprises a receiver of the communications device 300, a transmitter of the communications device 300, or a combination thereof. The input/output portion 306 is capable of receiving and/or providing information pertaining to emergency alert messages as described herein. In various configurations, the input/output portion 306 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof.

The processing portion 302 may be capable of performing functions pertaining to network congestion mitigation and/or prevention as described herein. In a basic configuration, the communications device 300 may include at least one memory portion 304. The memory portion 304 may comprise a storage medium having a tangible physical structure. Thus, the memory portion 304, as well as any computer-readable storage medium described herein, is not to be construed as a transient signal per se. Further, the memory portion 304, as well as any computer-readable storage medium described herein, is not to be construed as a propagating signal per se. The memory portion 304 may store any information utilized in conjunction with network congestion mitigation as described herein. Depending upon the exact configuration and type of processor, the memory portion 304 may be volatile (such as some types of RAM), non-volatile (such as ROM, flash memory, etc.), or a combination thereof. The mobile communications device 300 may include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile communications device 300.

The communications device 300 also may contain a user interface (UI) portion 308 allowing a user to communicate with the communications device 300. The UI portion 308 may be capable of rendering any information utilized in conjunction with emergency alert services as described herein. The UI portion 308 may provide the ability to control the communications device 300, via, for example, buttons, soft keys, voice actuated controls, a touch screen, movement of the mobile communications device 300, visual cues (e.g., moving a hand in front of a camera on the mobile communications device 300), or the like. The UI portion 308 may provide visual information (e.g., via a display), audio information (e.g., via speaker), mechanically (e.g., via a vibrating mechanism), or a combination thereof. In various configurations, the UI portion 308 may comprise a display, a touch screen, a keyboard, an accelerometer, a motion detector, a speaker, a microphone, a camera, a tilt sensor, or any combination thereof. The UI portion 308 may comprise means for inputting biometric information, such as, for example, fingerprint information, retinal information, voice information, and/or facial characteristic information.

The UI portion 308 may include a display for displaying multimedia such as, for example, application graphical user interfaces (GUIs), text, images, video, telephony functions such as Caller ID data, setup functions, menus, music, metadata, messages, wallpaper, graphics, Internet content, device status, preferences settings, map and location data, routes and other directions, points of interest (POI), and the like.

In some embodiments, the UI portion may comprise a user interface (UI) application. The UI application may interface with a client or operating system (OS) to, for example, facilitate user interaction with device functionality and data. The UI application may aid a user in entering message content, viewing received messages, answering/initiating calls, entering/deleting data, entering and setting user IDs and passwords, configuring settings, manipulating content and/or settings, interacting with other applications, or the like, and may aid the user in inputting selections associated with emergency messages as described herein.

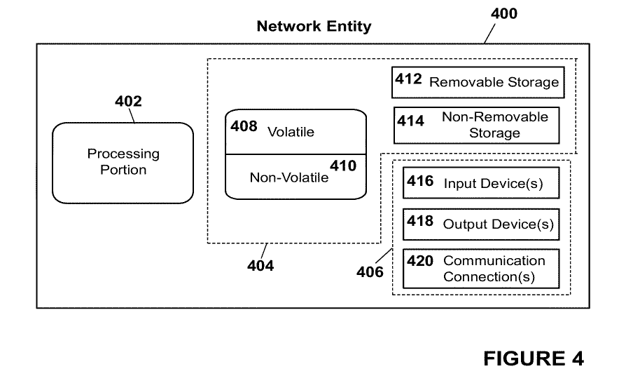

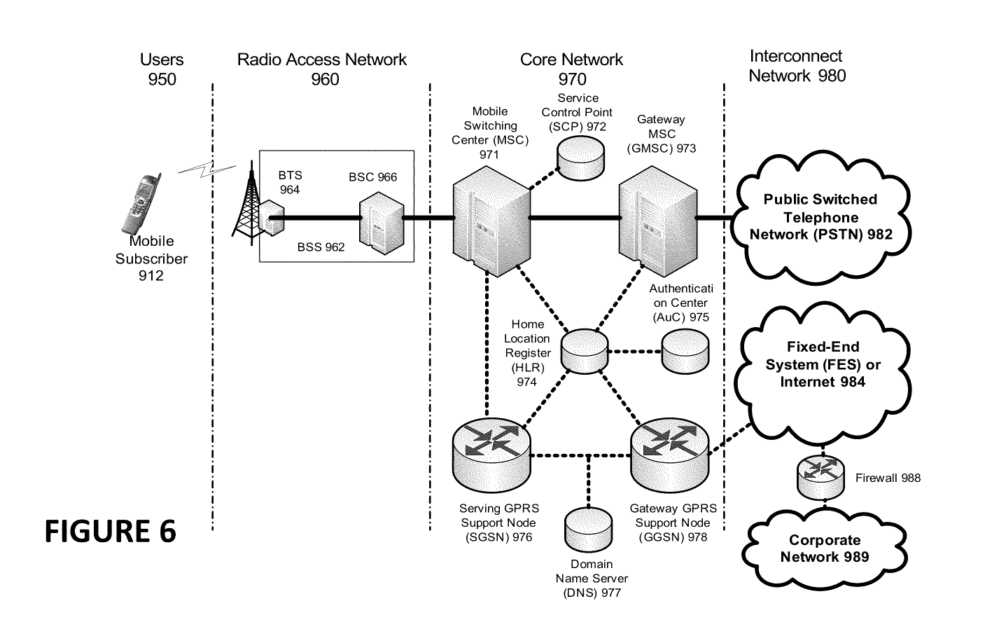

FIG. 4 is a block diagram of an example network entity 400 for facilitating the distribution of emergency alert messages. The network entity 400 may comprise hardware or a combination of hardware and software. The functionality needed to facilitate emergency alert message distribution may reside in any one or combination of network entities 400. The network entity 400 depicted in FIG. 6 may represent any appropriate network entity, or combination of apparatuses, such as a processor, a server, a gateway, a node, any appropriate entity, or any appropriate combination thereof. In an example embodiment, the network entity 400 may comprise the network server 130, the emergency server 113, or any appropriate combination thereof. It is emphasized that the block diagram depicted in FIG. 4 is exemplary and not intended to imply a specific implementation or configuration. Thus, the network entity 400 may be implemented in a single processor or multiple processors (e.g., single server or multiple servers, single gateway or multiple gateways, single system or multiple systems, etc.). Multiple systems may be distributed or centrally located. Multiple systems may communicate wirelessly, via hard wire, or a combination thereof.

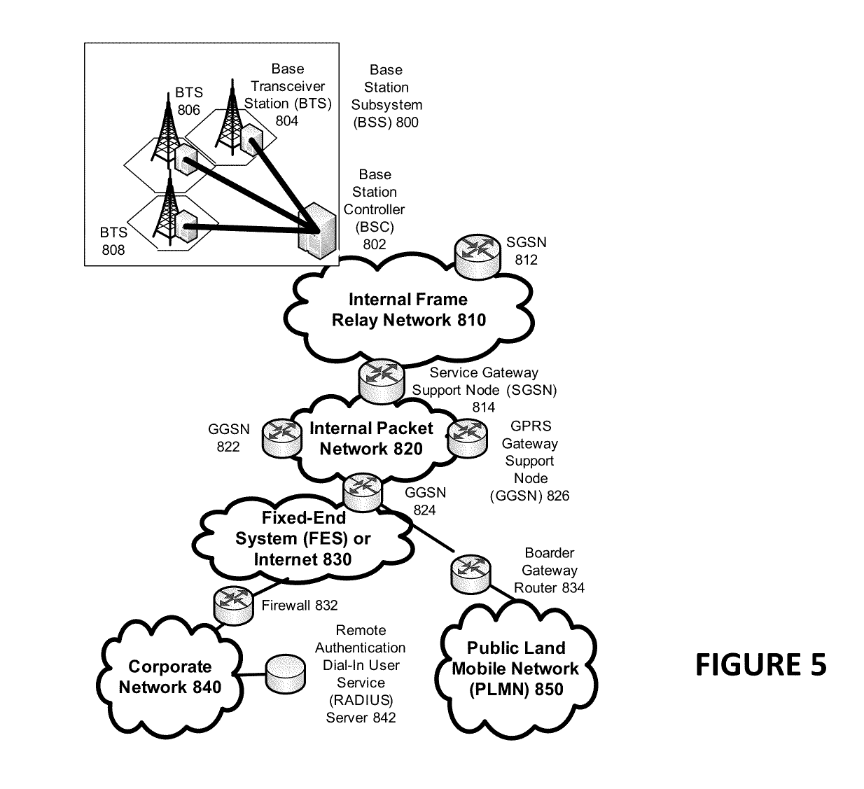

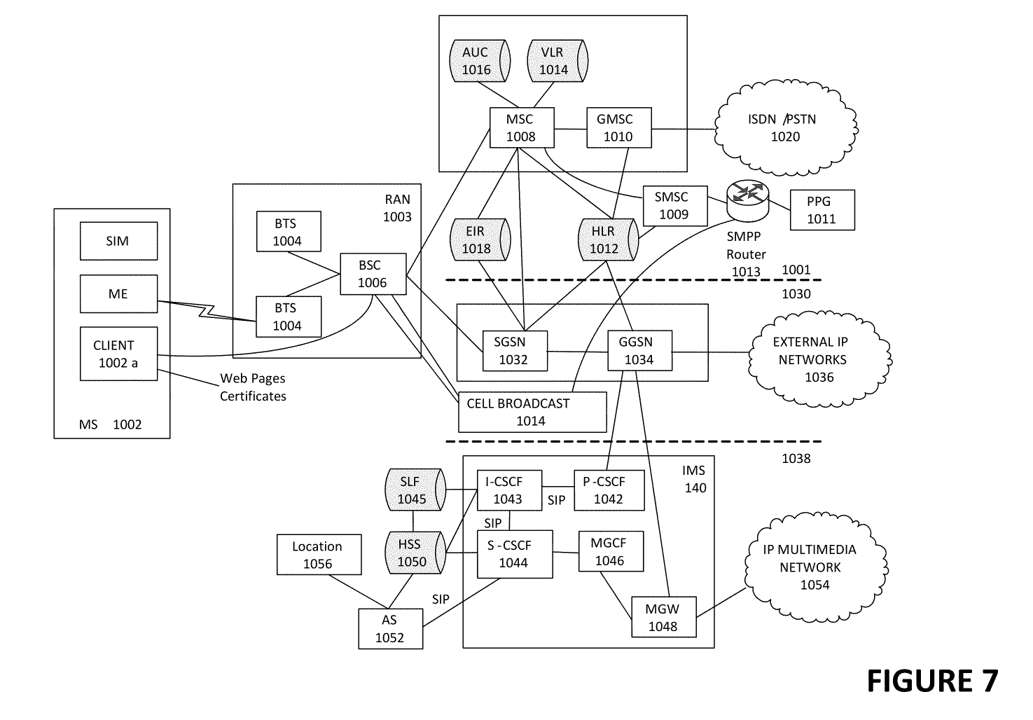

The network entity 400 may comprise hardware or a combination of hardware and software. When used in conjunction with a network, the functionality needed to determine appropriate recipients of an alert emergency message and generate an appropriate emergency alert message can reside in any one or combination of network entities. The network entity 400 depicted in FIG. 4 represents any appropriate network entity, or combination of network entities, such as a processor, a server, a gateway, a node, any appropriate entity depicted in FIG. 5, any appropriate entity depicted in FIG. 6, any appropriate entity depicted in FIG. 7, any appropriate entity depicted in FIG. 9, the network server depicted in FIG. 1, any appropriate entity, component, device, and/or circuitry of the relay center depicted in FIG. 1, any appropriate entity, component, device, and/or circuitry of the network depicted in FIG. 1, any appropriate entity, component, device, and/or circuitry of the emergency services network depicted in FIG. 1, any appropriate entity, component, device, and/or circuitry of the PSAP depicted in FIG. 1, or any appropriate combination thereof. In an example configuration, the network entity 400 comprises a component or various components of a cellular broadcast system wireless network. It is emphasized that the block diagram depicted in FIG. 4 is exemplary and not intended to imply a specific implementation or configuration. Thus, the network entity 400 can be implemented in a single processor or multiple processors (e.g., single server or multiple servers, single gateway or multiple gateways, etc.). Multiple network entities can be distributed or centrally located. Multiple network entities can communicate wirelessly, via hard wire, or a combination thereof.

In an example embodiment, the network entity 400 comprises a processor and memory coupled to the processor. The memory may comprise executable instructions that when executed by the processor cause the processor to effectuate operations associated with emergency alert message distribution. As evident from the herein description, a system or any portion thereof is not to be construed as software per se.

In an example embodiment, the network entity 400 comprises a processor and memory coupled to the processor. The memory may comprise executable instructions that when executed by the processor cause the processor to effectuate operations associated with network congestion mitigation services.

In an example configuration, the network entity 400 comprises a processing portion 402, a memory portion 404, and an input/output portion 406. The processing portion 402, memory portion 404, and input/output portion 406 are coupled together (coupling not shown in FIG. 4) to allow communications therebetween. The input/output portion 406 may be capable of receiving and/or providing information from/to a communications device and/or other network entities configured to be utilized with network congestion mitigation services. For example, the input/output portion 406 may include a wireless communications (e.g., 2.5G/3G/4G/GPS) card. The input/output portion 406 may be capable of receiving and/or sending video information, audio information, control information, image information, data, or any combination thereof. In an example embodiment, the input/output portion 406 may be capable of receiving and/or sending information to determine appropriate recipients of an emergency alert message and/or to generate an appropriate emergency alert message. In an example configuration, the input\output portion 406 may comprise and/or be coupled to a GPS receiver. In an example configuration, the network entity 400 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 406 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WI-FI finder, a two way GPS chipset or equivalent, or the like, or a combination thereof.

The processing portion 402 may be capable of performing functions associated with emergency alert message distribution as described herein. That is, a communications device (e.g., communications device 104) may perform functions internally (by the device) and/or utilize the network entity 400 to perform functions. For example, the processing portion 402 may be capable of, in conjunction with any other portion of the network entity 400, installing an application for emergency alert message generation and/or distribution, processing an application of emergency alert message generation and/or distribution, configuring the network entity 400 to function as a gateway for other devices to a network, determining the intended recipients of an emergency alert message, or the like, or any combination thereof. The processing portion 402, in conjunction with any other portion of the network entity 400, enables the network entity 400 to format messages into various formats when it is configured to distribute emergency messages.

In a basic configuration, the network entity 400 may include at least one memory portion 404. The memory portion 404 may comprise a storage medium having a tangible physical structure. Thus, the memory portion 404, as well as any computer-readable storage medium described herein, is not to be construed as a transient signal per se. The memory portion 404, as well as any computer-readable storage medium described herein, is not to be construed as a propagating signal per se. The memory portion 404 may store any information utilized in conjunction with network congestion mitigation services as described herein. Depending upon the exact configuration and type of processor, the memory portion 404 may be volatile 408 (such as some types of RAM), non-volatile 610 (such as ROM, flash memory, etc.), or a combination thereof. The network entity 400 may include additional storage (e.g., removable storage 412 and/or non-removable storage 414) including, but not limited to, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the network entity 400.

The network entity 400 also may contain communications connection(s) 420 that allow the network entity 400 to communicate with other devices, systems, or the like. A communications connection(s) can comprise communication media. Communication media typically embody computer readable instructions, data structures, program modules or other data in a modulated data signal such as a carrier wave or other transport mechanism and includes any information delivery media. By way of example, and not limitation, communication media include wired media such as a wired network or direct-wired connection, and wireless media such as acoustic, RF, infrared, and other wireless media. The term computer readable media as used herein includes both storage media and communication media. The network entity 400 also can include input device(s) 416 such as keyboard, mouse, pen, voice input device, touch input device, etc. Output device(s) 418 such as a display, speakers, printer, etc. also can be included.

Emergency alert message generation and/or distribution may be implemented in conjunction with various wireless communications networks. Some of which are described below.

FIG. 5 depicts an overall block diagram of an example packet-based mobile cellular network environment, such as a GPRS network, within which enhanced location based services may be implemented. In the example packet-based mobile cellular network environment shown in FIG. 5, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In example fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

FIG. 6 illustrates an architecture of a typical GPRS network within which text message generation for emergency services can be implemented. The architecture depicted in FIG. 6 is segmented into four groups: users 950, radio access network 960, core network 970, and interconnect network 980. Users 950 comprise a plurality of end users. Note, device 912 is referred to as a mobile subscriber in the description of network shown in FIG. 6. In an example embodiment, the device depicted as mobile subscriber 912 comprises a communications device (e.g., communications device 104). Radio access network 960 comprises a plurality of base station subsystems such as BSSs 962, which include BTSs 964 and BSCs 966. Core network 970 comprises a host of various network elements. As illustrated in FIG. 6, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 6, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 6, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

FIG. 7 illustrates an example block diagram view of a GSM/GPRS/IP multimedia network architecture within which text message generation for emergency services may be implemented. As illustrated, the architecture of FIG. 7 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 1017 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

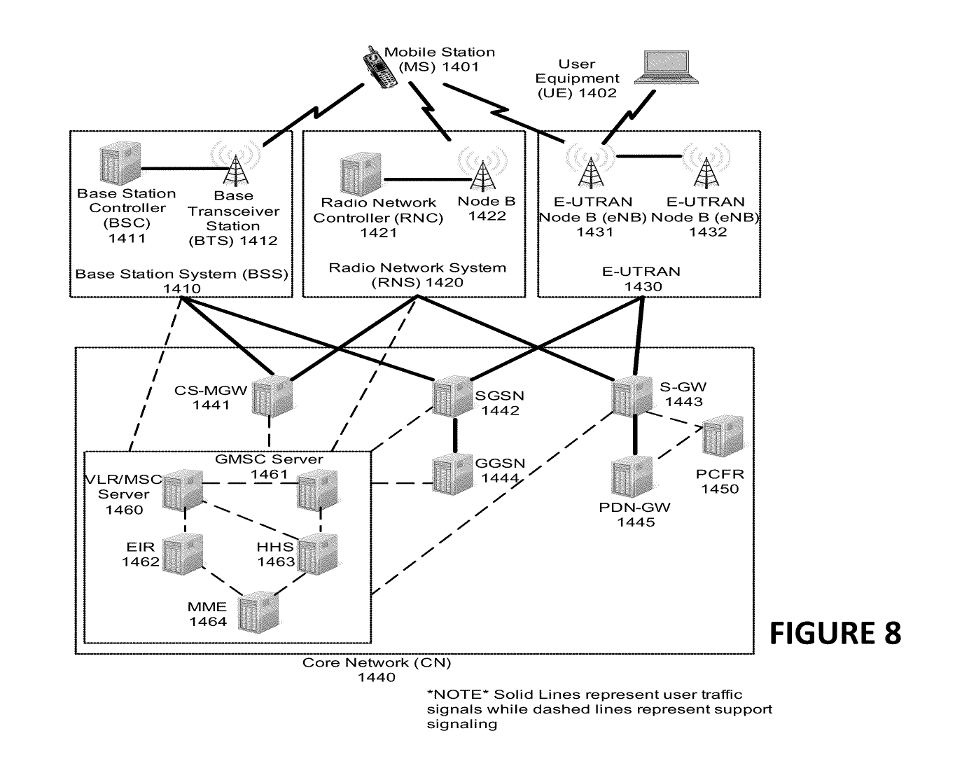

FIG. 8 illustrates a PLMN block diagram view of an example architecture in which text message generation for emergency services may be incorporated. Mobile Station (MS) 1401 is the physical equipment used by the PLMN subscriber. In one illustrative embodiment, communications device 104 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 8 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched—Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While example embodiments of network congestion mitigation services have been described in connection with various computing devices/processors, the underlying concepts may be applied to any computing device, processor, or system capable of implementing enhanced location based services. The various techniques described herein can be implemented in connection with hardware or software or, where appropriate, with a combination of both. Thus, the methods and apparatuses of using and implementing network congestion mitigation services may be implemented, or certain aspects or portions thereof, can take the form of program code (i.e., instructions) embodied in tangible storage media having a tangible physical structure. Examples of tangible storage media include floppy diskettes, CD-ROMs, DVDs, hard drives, or any other tangible machine-readable storage medium (computer-readable storage medium). Thus, a computer-readable storage medium is not a transient signal per se. A computer-readable storage medium is not a propagating signal per se. When the program code is loaded into and executed by a machine, such as a computer, the machine becomes an apparatus for implementing enhanced location based services. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for using and implementing network congestion mitigation services also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing enhanced location based services. When implemented on a general-purpose processor, the program code combines with the processor to provide a unique apparatus that operates to invoke the functionality of enhanced location based services.

While emergency alert message services have been described in connection with the various embodiments of the various figures, it is to be understood that other similar embodiments can be used or modifications and additions can be made to the described embodiments for implementing enhanced location based services without deviating therefrom. For example, one skilled in the art will recognize that emergency alert message services as described in the present application may apply to any environment, whether wired or wireless, and may be applied to any number of such devices connected via a communications network and interacting across the network. Therefore, emergency alert message services should not be limited to any single embodiment, but rather should be construed in breadth and scope in accordance with the appended claims.

1. A method comprising:
receiving an emergency call comprising reported information, the emergency call associated with an emergency condition;
generating an emergency alert message comprising at least a portion of the reported information;
determining a characteristic associated with potential recipients of the emergency alert message;
determining whether a number associated with the emergency call exceeds a predetermined threshold of emergency calls that have been received;
if the number exceeds the predetermined threshold, distributing the emergency alert message to a plurality of recipients associated with the characteristic; and
if the number is less than or equal to the predetermined threshold, refraining from distributing the emergency alert message to the plurality of recipients until at least one more emergency calls is received.

2. The method of claim 1, wherein the characteristic comprises a geographic region, and the recipients are located within the geographic region.

3. The method of claim 1, the method further comprising:
receiving a second emergency call, the second emergency call comprising second reported information associated with the emergency condition;
comparing the reported information to the second reported information;
determining a set of information that is contained in the reported information and the second reported information; and
incorporating the set of information in the emergency alert message.

4. The method of claim 1, the method further comprising:
receiving a plurality of emergency calls, each emergency call of the plurality of emergency calls associated with a second emergency condition;
determining a number of the plurality of emergency calls that have been received;
determining whether the number is greater than a predetermined threshold;
if the number is greater than a predetermined threshold, distributing a second emergency alert message to the recipients; and
if the number is not greater than the predetermined threshold, waiting until the number is greater than the predetermined threshold before distributing the second emergency alert message to the recipients.

5. The method of claim 1, the method comprising:
receiving a new emergency call comprising new reported information, the new emergency call associated with the emergency condition;
determining whether the portion of the reported information comprises the new information;
if the portion of the reported information does not comprise the new information, generating a new emergency alert message, wherein the new emergency alert message comprises the new information; and
distributing the new emergency alert message to the recipients.

6. The method of claim 1, wherein the emergency alert message comprises at least one of details of the emergency condition or a status of an emergency response to the emergency condition.

7. The method of claim 1, the method further comprising:
distributing the emergency alert message to at least one emergency caller responsive to receiving an emergency call from the emergency caller.

8. The method of claim 1, the method further comprising:
identifying the recipients associated with one or more characteristics, wherein the identifying comprises:
accessing a user profile associated with a respective recipient;
retrieving data from the user profile; and
matching the data to at least one of the one or more characteristics.

9. A device comprising:
a memory comprising executable instructions; and
a processor in communications with the memory, the instructions, when executed by the processor, cause the processor to effectuate operations comprising:
receiving an emergency call comprising reported information, the emergency call associated with an emergency condition;
generating an emergency alert message comprising at least a portion of the reported information;
determining a characteristic associated with potential recipients of the emergency alert message;
determining whether a number associated with the emergency call exceeds a predetermined threshold of emergency calls that have been received;
if the number exceeds the predetermined threshold, distributing the emergency alert message to a plurality of recipients associated with the characteristic; and
if the number is less than or equal to the predetermined threshold, refraining from distributing the emergency alert message to the plurality of recipients until at least one more emergency calls is received.

10. The device of claim 9, wherein the characteristics comprises a geographic region, and the recipients are located within the geographic region.

11. The device of claim 9, wherein the processor is further configured to execute the instructions to perform operations comprising:
receiving a second emergency call, the second emergency call comprising second reported information associated with the emergency condition;
comparing the reported information to the second reported information;
determining a set of information that is contained in the reported information and the second reported information; and
incorporating the set of information in the emergency alert message.

12. The device of claim 9, wherein the processor is further configured to execute the instructions to perform operations comprising:
receiving a plurality of emergency calls, each emergency call of the plurality of emergency calls associated with a second emergency condition;
determining a number of the plurality of emergency calls that have been received;
determining whether the number is greater than a predetermined threshold;
if the number is greater than a predetermined threshold, distributing a second emergency alert message to the recipients; and
if the number is not greater than the predetermined threshold, waiting until the number is greater than the predetermined threshold before distributing the second emergency alert message to the recipients.

13. The device of claim 9, wherein the processor is further configured to execute the instructions to perform operations comprising:
receiving a new emergency call comprising new reported information, the new emergency call associated with the emergency condition;
determining whether the portion of the reported information comprises the new information;
if the portion of the reported information does not comprise the new information, generating a new emergency alert message, wherein the new emergency alert message comprises the new information; and
distributing the new emergency alert message to the recipients.

14. The device of claim 9, wherein the emergency alert message comprises at least one of details of the emergency condition or a status of an emergency response to the emergency condition.

15. The device of claim 9, wherein the processor is further configured to execute the instructions to perform operations comprising:
distributing the emergency alert message to at least one emergency caller responsive to receiving an emergency call from the emergency caller.

16. The device of claim 9, wherein the processor is further configured to execute the instructions to perform operations comprising:
identifying the recipients associated with one or more characteristics, wherein the identifying comprises:
accessing a user profile associated with a respective recipient;
retrieving data from the user profile; and
matching the data to at least one of the one or more characteristics.

17. A computer-readable storage medium having executable instructions stored thereon that when executed by a processor cause the processor to effectuate operations comprising:
receiving an emergency call comprising reported information, the emergency call associated with an emergency condition;
generating an emergency alert message comprising at least a portion of the reported information;
determining a characteristic associated with potential recipients of the emergency alert message;
determining whether a number associated with the emergency call exceeds a predetermined threshold of emergency calls that have been received;
if the number exceeds the predetermined threshold, distributing the emergency alert message to a plurality of recipients associated with the characteristic; and
if the number is less than or equal to the predetermined threshold, refraining from distributing the emergency alert message to the plurality of recipients until at least one more emergency calls is received.

18. The computer-readable storage medium of claim 17, wherein the characteristic comprises a geographic region, and the recipients are located within the geographic region.

19. The computer-readable storage medium of claim 17, the operations further comprising:
receiving a second emergency call, the second emergency call comprising second reported information associated with the emergency condition;
comparing the reported information to the second reported information;
determining a set of information that is contained in the reported information and the second reported information; and
incorporating the set of information in the emergency alert message.

20. The computer-readable storage medium of claim 17, the operations further comprising
receiving a plurality of emergency calls, each emergency call of the plurality of emergency calls associated with a second emergency condition;
determining a number of the plurality of emergency calls that have been received;
determining whether the number is greater than a predetermined threshold;
if the number is greater than a predetermined threshold, distributing a second emergency alert message to the recipients; and
if the number is not greater than the predetermined threshold, waiting until the number is greater than the predetermined threshold before distributing the second emergency alert message to the recipients.
